(19) United States
(12) Patent Application Publication
(10) Pub. No.: US 2018/0109036 A1
(43) Pub. Date: Apr. 19, 2018

(54) CONNECTOR

(71) Applicant: YAZAKI CORPORATION, Tokyo (JP)

(72) Inventors: Yosuke AKAGI, Shizuoka (JP); Kaoru MATSUMURA, Shizuoka (JP)

(73) Assignee: YAZAKI CORPORATION, Tokyo (JP)

(21) Appl. No.: 15/782,919

(22) Filed: Oct. 13, 2017

(30) Foreign Application Priority Data
Oct. 17, 2016 (JP) 2016-203456

(51) Int. Cl. H01R 13/641; H01R 13/629; H01R 13/506

(52) U.S. Cl. CPC H01R 13/641; H01R 13/506; H01R 13/62933

(57) ABSTRACT

A connector includes a housing provided with a sub-housing accommodation chamber accommodating a sub-housing to accommodate and hold a male terminal, and fitted into or detached from a counterpart housing. A tab deformation detection mechanism that detects deformation of a tab portion of the male terminal is provided in the housing.

### CROSS REFERENCE TO RELATED APPLICATIONS

This application claims the priority of Japanese Patent Application No. 2016-203456, filed on Oct. 17, 2016, the entire content of which are incorporated herein by reference.

### BACKGROUND

### Technical Field

The present invention relates to a connector such as a lever type connector in which male and female housings are fitted and detached by a reciprocation operation of a lever using a weak insertion force.

### Related Art

This kind of lever type connector includes one disclosed by JP 10-241801 A.

This lever type connector 1 includes, as shown in FIGS. 18 and 19, a split connector 2 formed by fitting a plurality of male sub-housings 4 that house and hold a male terminal 5 into a frame 3 in a box shape, a lever 7 rotatably supported via a lever support portion 6 projected from the frame 3 of the split connector 2, and a female connector 8 as a counterpart from which an engagement protrusion 9 engaged with a cam groove 7a formed in the lever 7 is projected and fitted into/detached from a hood portion 4a of each of the male sub-housings 4 by operating the lever 7.

Then, when the female connector 8 is fitted into the split connector 2 by operating the lever 7, a female terminal (not shown) of the female connector 8 is connected to a tab portion 5a of the male terminal 5 of each of the male sub-housings 4 of the split connector 2.

### SUMMARY

In the lever type connector 1 of conventional type, however, the female connector 8 can be fitted into the split connector 2 even if the tab portion 5a of the male terminal 5 of the male sub-housing 4 is deformed and thus, if the tab portion 5a of the male terminal 5 is deformed, the split connector 2 is handled as a fitting defective product. This affects malfunctioning in a process of manufacturing wire harnesses W/H made of a plurality of wires W to which the male terminal 5 having the tab portion 5a attached to the lever type connector 1 is connected.

Thus, the present invention is made to solve the above problem and an object thereof is to provide a connector capable of eliminating fitting defective products by being able to detect deformation of a tab portion of a male terminal before connector fitting.

A connector according to an aspect of the present invention includes a housing provided with a sub-housing accommodation chamber accommodating a sub-housing to accommodate and hold a male terminal, and fitted into or detached from a counterpart housing. A tab deformation detection mechanism that detects deformation of a tab portion of the male terminal is provided in the housing.

A partition wall partitioning the sub-housing accommodating chamber may be provided with a tab insertion hole as the tab deformation detection mechanism through which the tab portion is inserted.

The connector may further include a male housing as the housing having a hood portion, a lever supported by the male housing via a spindle, a moving plate that positions the tab portion inside the hood portion, and a female housing as the counterpart housing accommodating a female terminal and fitted to or detached from the hood portion. By causing the lever to perform a forward movement operation while a cam follower formed on the female housing is engaged with a cam groove formed in the lever, the female housing may be fitted into the male housing by moving the female housing to a back side in the hood portion together with the moving plate.

The tab insertion hole may be formed in a same position as that of a positioning hole formed in the moving plate with a same diameter as that of the positioning hole.

As described above, a connector according to an aspect of the present invention can easily and reliably detect deformation of the tab portion of the male terminal before being fitted into the counterpart housing by providing a tab deformation detection mechanism that detects deformation of the tab portion of the male terminal in the housing.

If a tab insertion hole allowing the tab portion of the male terminal as a tab deformation detection mechanism to pass through is formed in a partition wall that partitions sub-housing accommodation chambers of the housing, deformation of the tab portion of the male terminal can easily and reliably be detected before the sub-housing accommodating and holding the male terminal whose tab portion is deformed being fitted into the sub-housing accommodation chamber of the housing so that fitting defective products of the counterpart housing can be eliminated. Accordingly, malfunctioning of tab deformation defective products in a process of manufacturing wire harnesses made of a plurality of wires to which the male terminal having the tab portion attached to a connector is connected can be eliminated as soon as possible.

If the female housing is fitted into the male housing by moving to the back side in the hood portion of the male housing together with a moving plate by performing the forward movement operation of the lever, operability of the moving plate can be further improved.

If the tab insertion hole of the partition wall is formed in the same position as that of a positioning hole formed in the moving plate with the same diameter as that of the positioning hole, the tab deformation detection mechanism can be created easily at low cost.

### BRIEF DESCRIPTION OF DRAWINGS

FIG. 1 is an exploded perspective view of a lever type connector according to an embodiment of the present invention;

FIG. 2 is a perspective view before a male connector of the lever type connector according to the present embodiment is assembled;

FIG. 3 is a sectional view before the male connector according to the present embodiment is assembled;

FIG. 4A is a principal portion sectional view during assembly of the male connector according to the present embodiment and FIG. 4B is a principal portion sectional view during assembly of the male connector when a male terminal is deformed;

FIG. 5A is a perspective view before a lever of the male connector according to the present embodiment is assembled and FIG. 5B is a perspective view showing a state in which a female connector is set to the male connector;

FIG. 6 is a side view before the lever of the male connector according to the present embodiment is assembled;

FIG. 7 is a side view during assembly of the lever according to the present embodiment;

FIG. 8 is a side view when lifting of a moving plate by a backward movement operation of the lever according to the present embodiment is started;

FIG. 9 is a side view when lifting of the moving plate according to the present embodiment (when the lever is temporarily locked) is completed;

FIG. 10 is a side view showing an unfitted state in which the female connector is set to the male connector according to the present embodiment;

FIG. 11 is a side view when a forward movement operation of the lever according to the present embodiment is started;

FIG. 12 is a side view during the forward movement operation of the lever according to the present embodiment;

FIG. 13 is a side view when the forward movement operation of the lever according to the present embodiment is completed (fitting is completed);

FIG. 14 is a side view before the backward movement operation of the lever according to the present embodiment is started when the female connector according to the present embodiment is detached;

FIG. 15 is a side view when lifting of the moving plate by the backward movement operation of the lever according to the present embodiment is started;

FIG. 16 is a side view while the moving plate according to the present embodiment is lifted;

FIG. 17 is a side view when lifting of the moving plate according to the present embodiment is completed (detaching is completed);

FIG. 18 is a perspective view of a conventional lever type connector; and

FIG. 19 is a sectional view of the conventional lever type connector.

### DETAILED DESCRIPTION

Hereinafter, an embodiment of the present invention will be described based on the drawings.

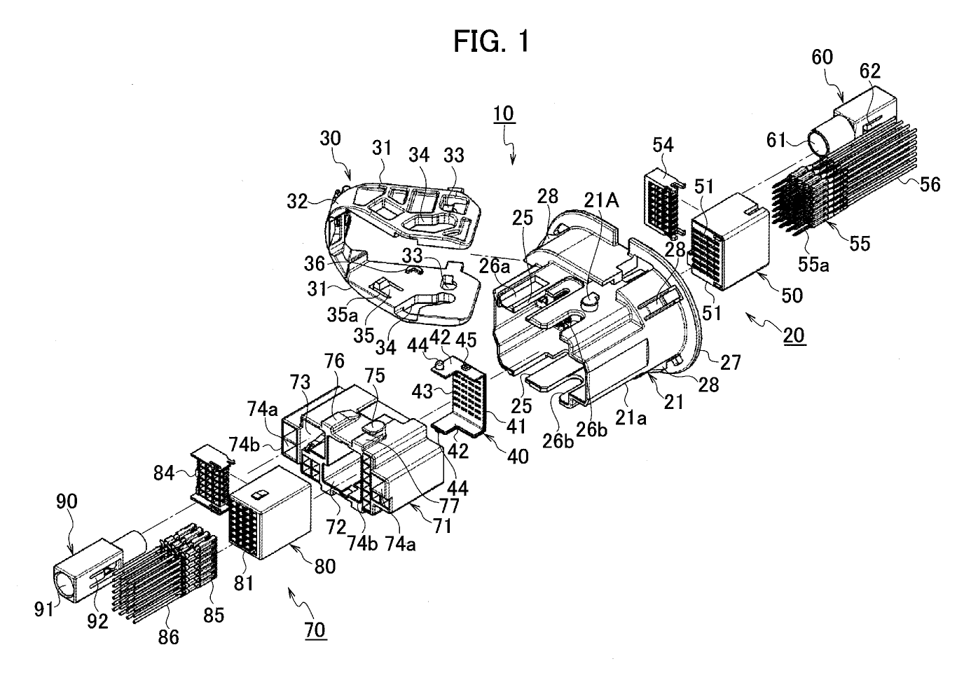

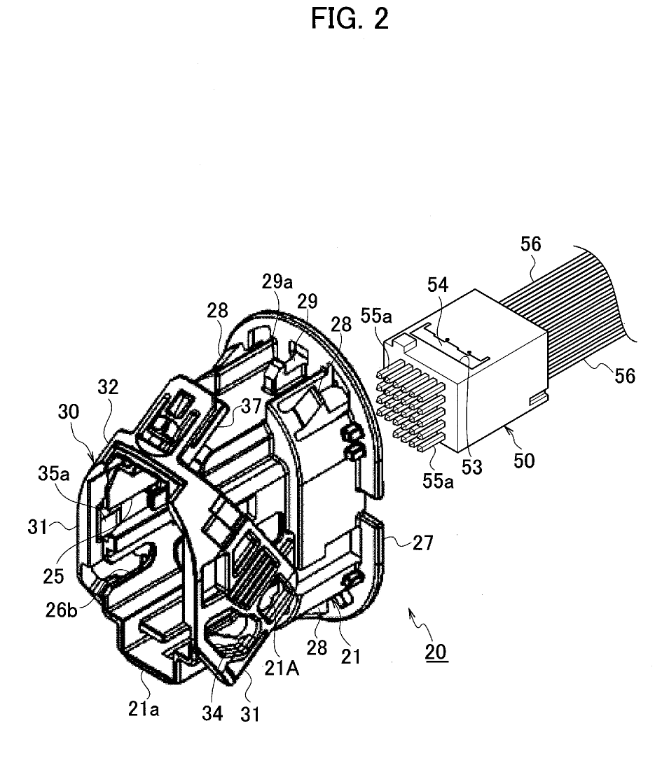

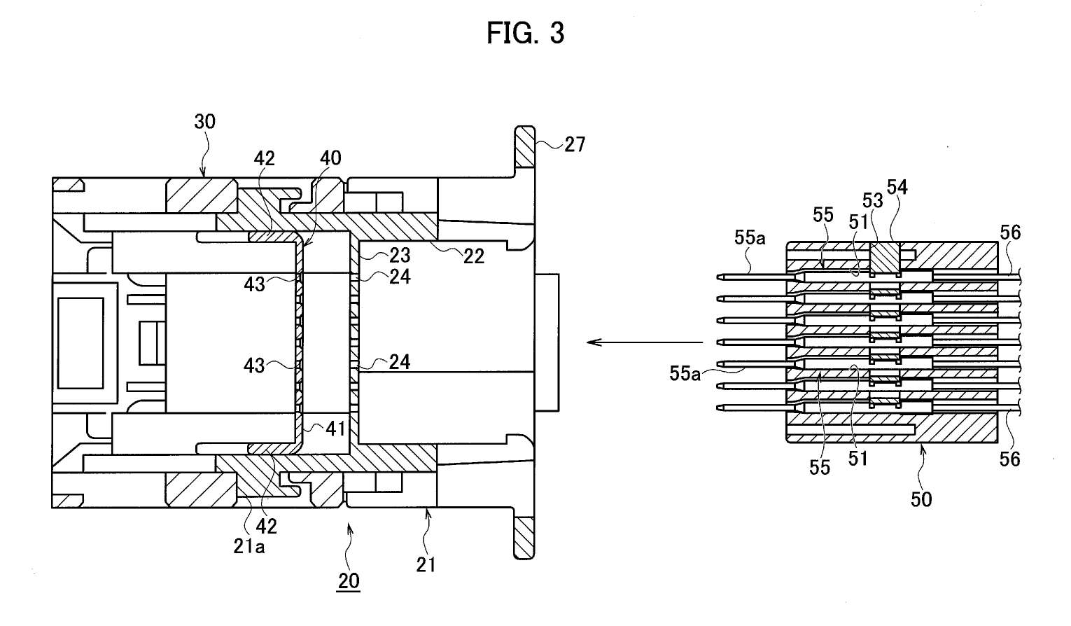

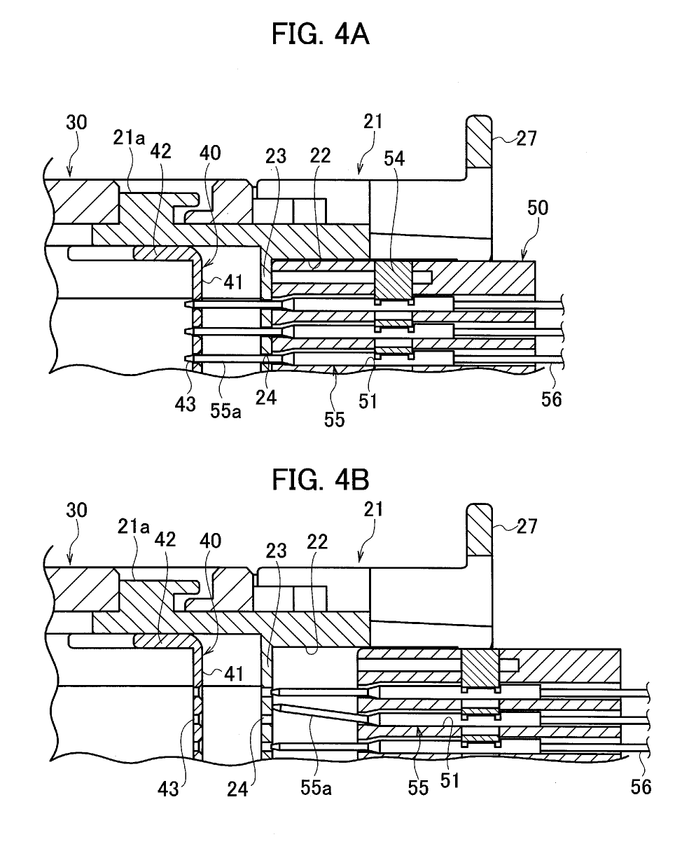

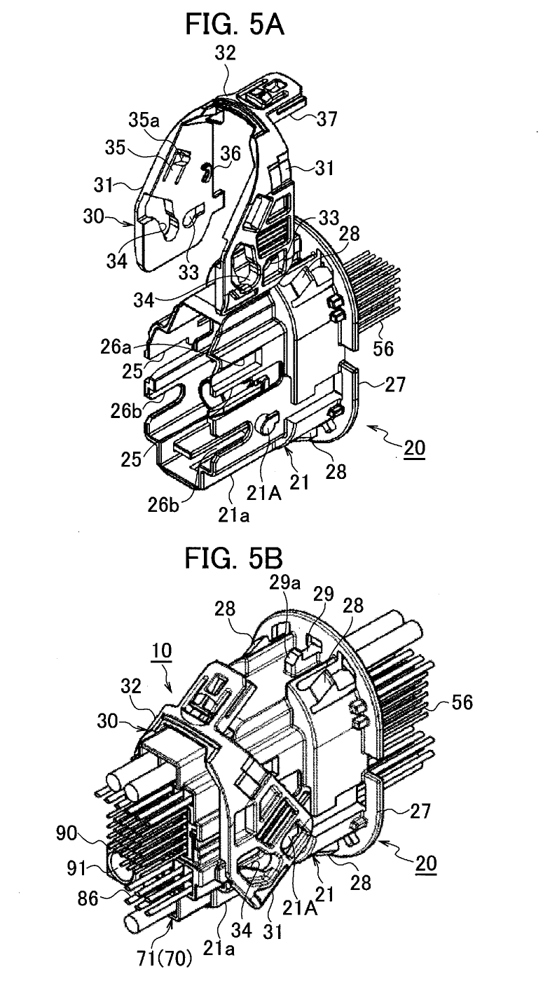

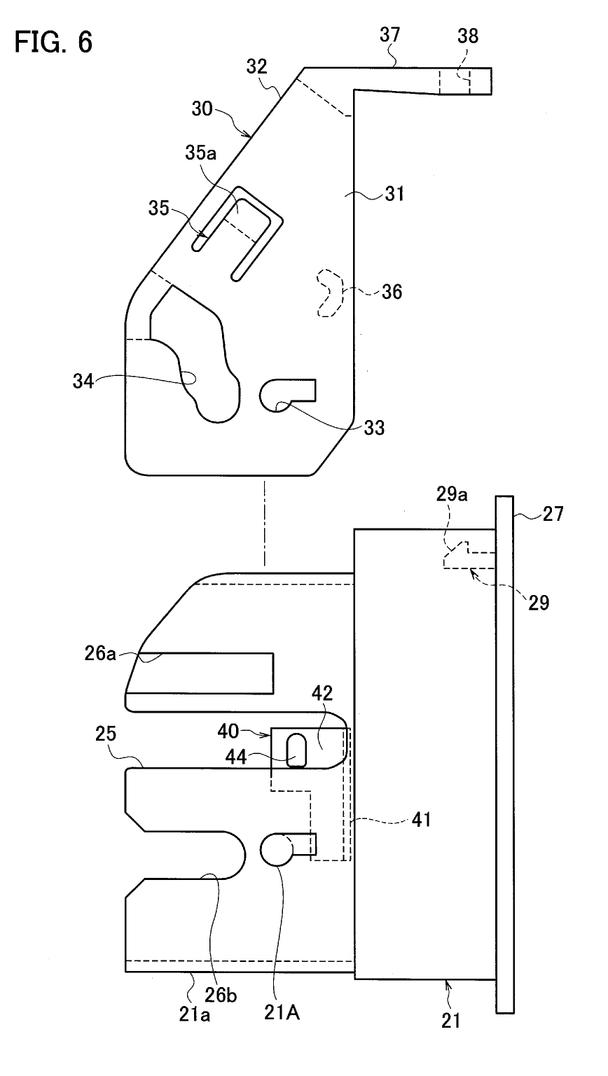

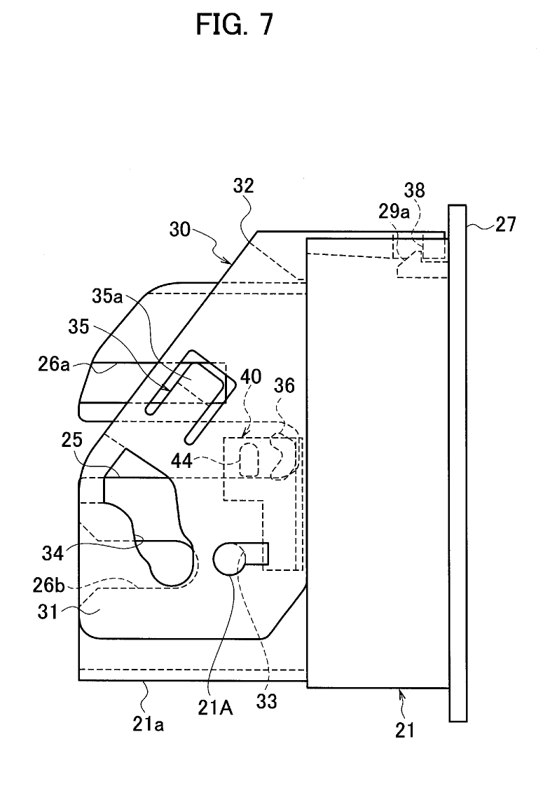

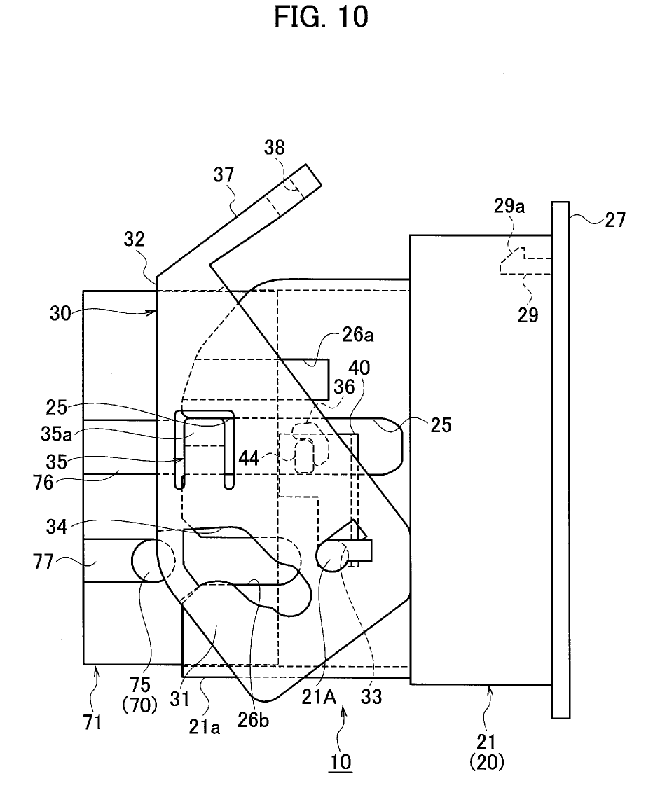

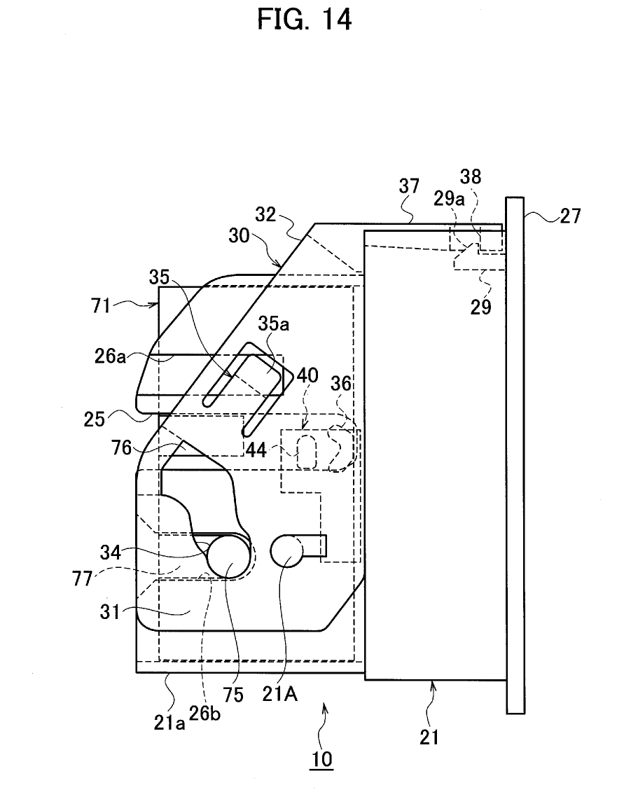

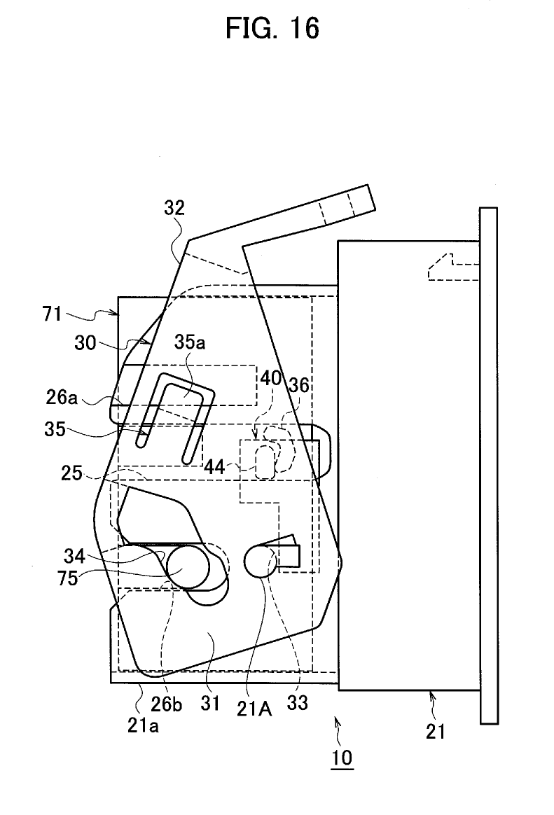

FIG. 1 is an exploded perspective view of a lever type connector according to an embodiment of the present invention, FIG. 2 is a perspective view before a male connector of the lever type connector is assembled, FIG. 3 is a sectional view before the male connector is assembled, FIG. 4A is a principal portion sectional view during assembly of the male connector, FIG. 4B is a principal portion sectional view during assembly of the male connector when a male terminal is deformed, FIG. 5A is a perspective view before a lever of the male connector is assembled, FIG. 5B is a perspective view showing a state in which a female connector is set to the male connector, FIG. 6 is a side view before the lever of the male connector is assembled, FIGS. 7 to 9 are side views successively showing an assembly process of the lever, FIGS. 10 to 13 are side views successively showing a fitting process of the male connector and the female connector, and FIGS. 14 to 17 are side views successively showing a detachment process of the male connector and the female connector.

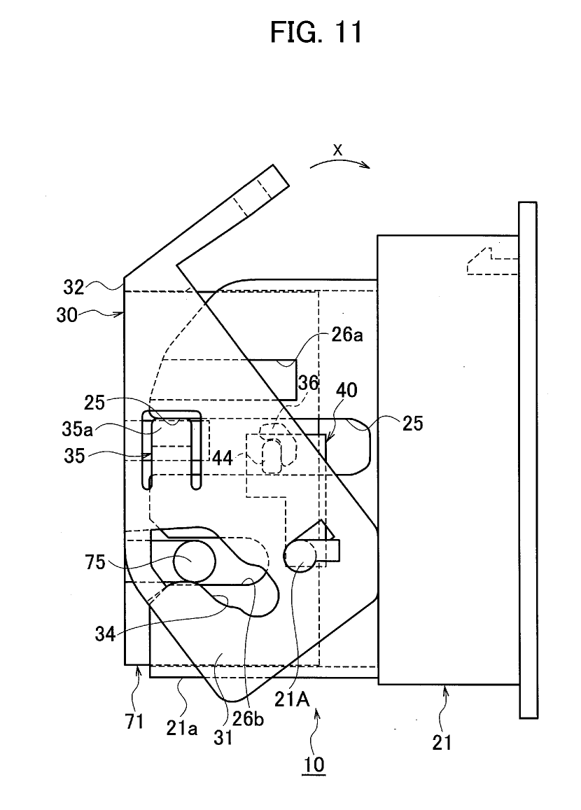

As shown in FIG. 1, a lever type connector 10 is made of a pair of male and female connectors 20, 70 that can be fitted into and detached from each other and is used as, for example, a front door connector of an automobile. The male connector 20 includes a male housing 21 having a hood portion 21a with a tubular shaped and formed on the front side, a lever 30 rotatably supported by the male housing 21 via a spindle 21A, a moving plate 40 positioning a tab portion 55a of a male terminal 55 inside the hood portion 21a, a male sub-housing 50 accommodated in a sub-housing accommodation chamber 22 formed in the male housing 21 and forming a male sub-connector, and a male coaxial sub-housing 60 accommodated in a sub-housing insertion hole (not shown) formed in the male housing 21. The female connector 70 includes a female housing 71 having a cam follower 75 engaged with a cam groove 34 formed in the lever 30 formed by being integrally projected and fitted into and detached from the hood portion 21a of the male housing 21, a female sub-housing 80 accommodated in a sub-housing accommodation chamber 72 formed in the female housing 71, and a female coaxial sub-housing 90 accommodated in a sub-housing insertion hole 73 formed in the female housing 71. Then, by performing, as shown in FIG. 11, a forward movement operation (indicated by an arrow X in FIG. 11) of the lever 30 while the cam follower 75 of the female housing 71 is engaged with the cam groove 34 of the lever 30, the female housing 71 is moved to the back side inside the hood portion 21a together with the moving plate 40 to be fitted into the male housing 21.

As shown in FIGS. 3 and 4, the male housing 21 is made of synthetic resin and a partition wall 23 that partitions the hood portion 21a and the sub-housing accommodation chamber 22 has a plurality of tab insertion holes 24 through which the tab portion 55a of the male terminal 55 is allowed to pass through as a tab deformation detection mechanism formed therein. Each of the tab insertion holes 24 is formed in the same position as that of a positioning hole 43 formed in the moving plate 40 to allow the tab portion 55a of the male terminal 55 to pass through with the same diameter as that of the positioning hole 43 and, as shown in FIGS. 4A and 4B, deformation of the tab portion 55a of the male terminal 55 accommodated and held in a cavity 51 of the male sub-housing 50 is detected by each of the tab insertion holes 24. That is, if, as shown in FIG. 4A, the tab portion 55a of the male terminal 55 is not deformed, the tab portion 55a of the male terminal 55 can be inserted through the tab insertion hole 24 and so the male sub-housing 50 can be fitted into the sub-housing accommodation chamber 22 of the male housing 21 and if, as shown in FIG. 4B, the tab portion 55a of the male terminal 55 is deformed, the tab portion 55a of the male terminal 55 cannot be inserted through the tab insertion hole 24 and so the male sub-housing 50 cannot be fitted into the sub-housing accommodation chamber 22 of the male housing 21 and deformation of the tab portion 55a of the male terminal 55 accommodated and held in the cavity 51 of the male sub-housing 50 is detected.

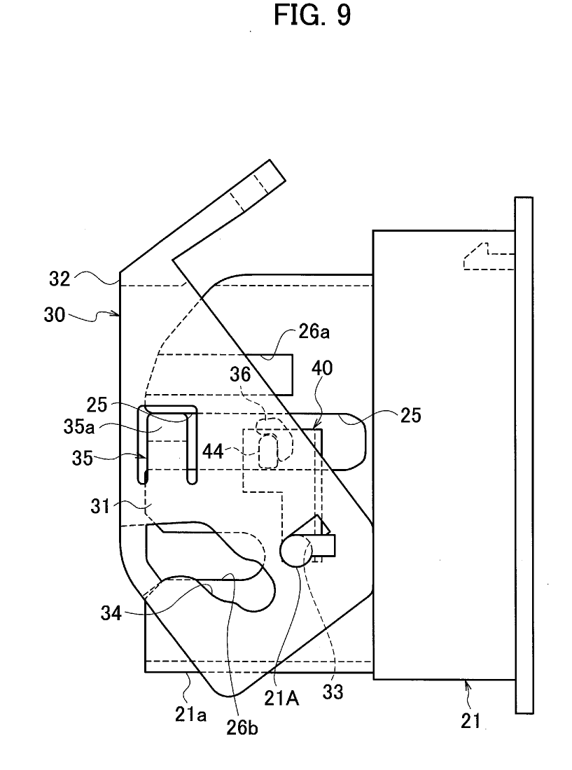

As shown in FIGS. 1, 2, 5, and 6, a groove portion 25 in a notched shape for temporary locking of the lever 30 is formed in the center of each of both sidewalls of the hood portion 21a of the male housing 21. The pair of groove portions 25, 25 functions as a guiderail when a boss 44 of the moving plate 40 or one guide protrusion 76 of the female housing 71 moves. Further, receiving grooves 26a, 26b in recessed and notched shapes into which a locking protrusion 35a of an elastic locking piece 35 of the lever 30 and another guide protrusion 77 of the female housing 71 are inserted are formed respectively in positions sandwiching each of the groove portions 25 in both sidewalls of the hood portion 21a. Incidentally, when the lever 30 is temporarily locked as shown in FIG. 9, the locking protrusion 35a of the elastic locking piece 35 of the lever 30 is locked into a groove surface of the groove portion 25 of the hood portion 21a.

A flange portion 27 in an annular plate shape is formed on an outer circumference of a rear end of the male housing 21 by being integrally projected. A recessed groove of an annular seal portion on the front side of a grommet made of rubber (not shown) is fitted into the flange portion 27 in an annular shape. Further, two pairs of locking protrusions 28, 28, each formed on upper side and lower side, are formed on the outer circumference of the rear end of the male housing 21 by being integrally projected. Then, if the male housing 21 is passed through a mounting hole of a panel of an automobile (not shown) from the door side, the lever type connector 10 is attached to the mounting hole of the panel in a sealed state via the annular seal portion on the front side of the grommet by the tips of each pair of the locking protrusions 28, 28 of the male housing 21 being locked by the surface on the body side around the mounting hole of the panel.

Further, as shown in FIGS. 5A, 5B, and 6, an elastic locking piece 29 with a locking protrusion 29a projected therefrom is formed in the center on the upper side of the flange portion 27 of the male housing 21 by being integrally projected. The locking protrusion 29a is freely lockable into and detachable from a locking hole 38 formed in a protruding piece 37 of the lever 30.

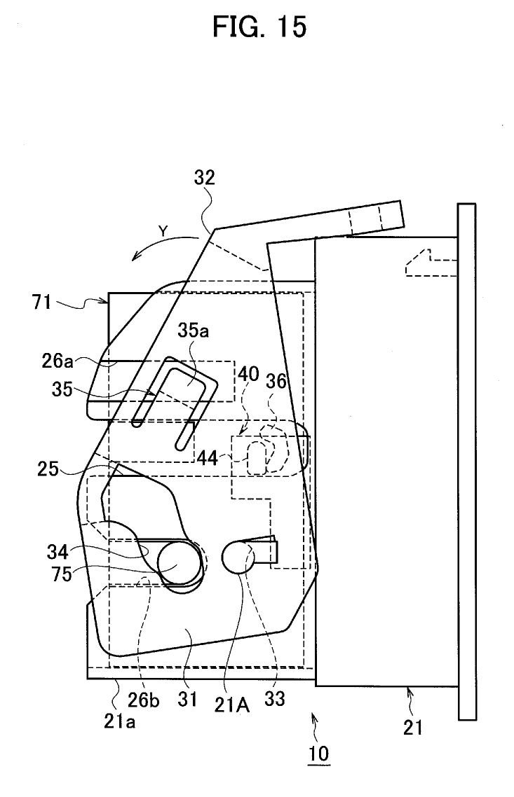

As shown in FIGS. 1, 2, 5, and 6, the lever 30 is integrally formed from a pair of arm portions 31, 31 and an operation portion 32 linking the pair of arm portions 31, 31 using synthetic resin. Each of the arm portions 31 has a bearing hole 33 that rotatably supports each of the spindles 21A formed to protrude on upper side and lower side of the outer circumferential surface of the hood portion 21a of the male housing 21 by being integrally projected therefrom formed therein. Further, each of the arm portions 31 has a cam groove 34 engaged with the cam follower 75 formed in the female housing 71 formed therein. Then, as shown in FIGS. 11 to 13, the male and female housings 21, 71 are fitted by a forward movement operation (indicated by the arrow X in FIG. 11) of the operation portion 32 of the lever 30 via the cam groove 34 and the cam follower 75 using a weak insertion force and, as shown in FIGS. 15 to 17, the male and female housings 21, 71 are detached by a backward movement operation (indicated by an arrow Y in FIG. 15) of the operation portion 32 of the lever 30 via the cam groove 34 and the cam follower 75 using a weak insertion force.

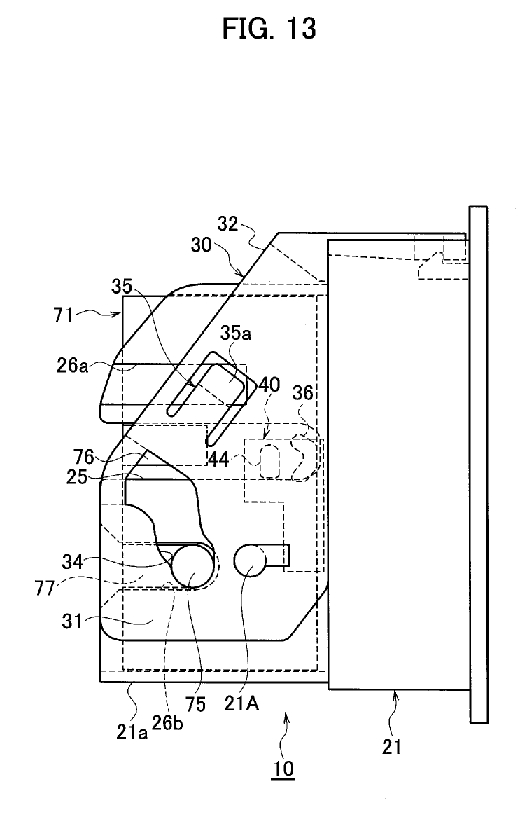

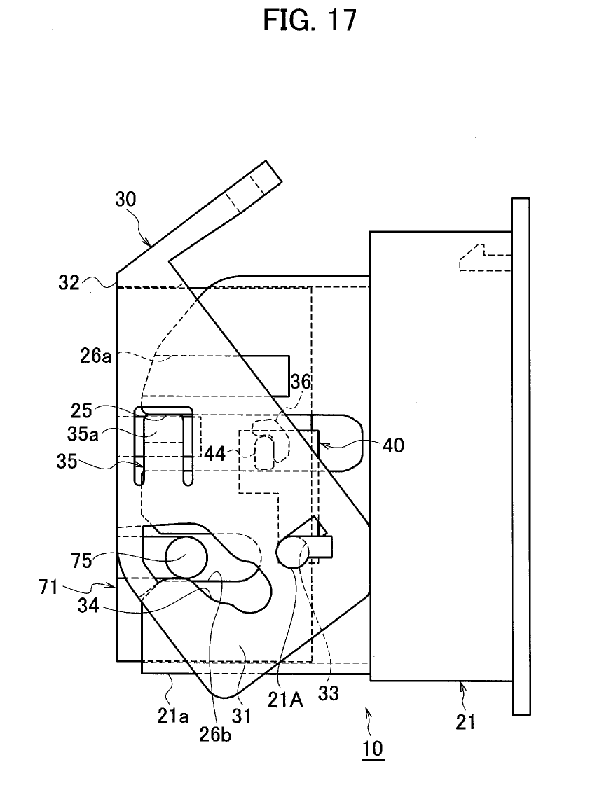

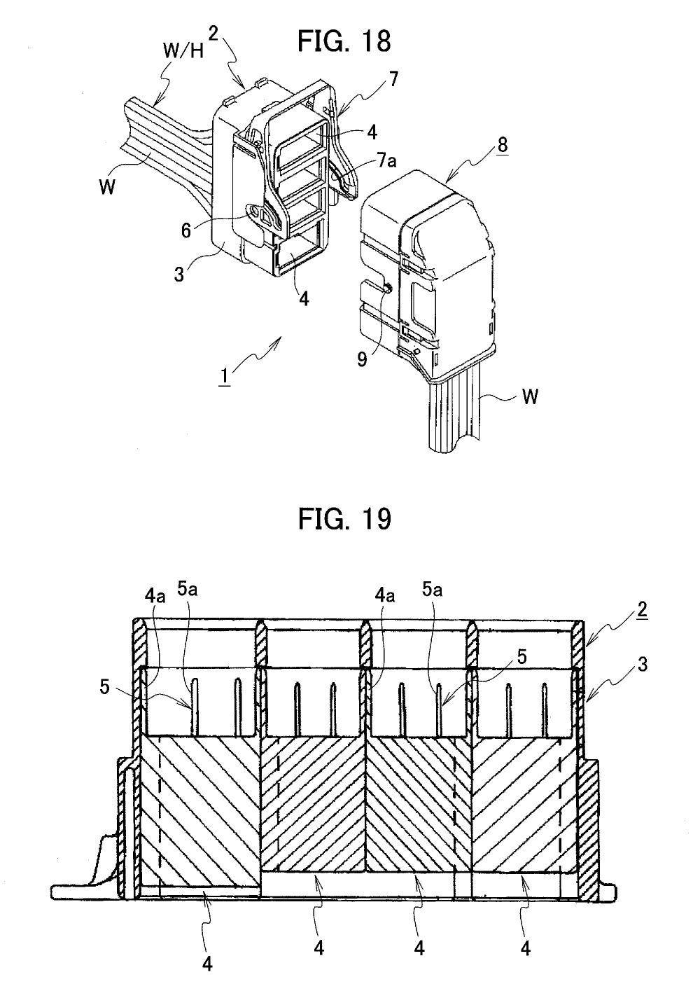

Each of the arm portions 31 has the elastic locking piece 35 with the locking protrusion 35a projected therefrom formed by notching. The lever 30 is held in a temporary locking position shown in FIGS. 9 and 17 and in a rotation control position shown in FIGS. 13 and 14 by the locking protrusion 35a of the elastic locking piece 35 being elastically locked into the groove surface of the groove portion 25 in a notched shape and the receiving groove 26a in a recessed shape formed in the sidewall of the hood portion 21a of the male housing 21 respectively.

Further, as shown in FIGS. 1, 5, and 6, a lib 36 that comes into contact with the boss 44 formed on the moving plate 40 when the female housing 71 is not fitted (when the lever 30 is temporarily locked as shown in FIG. 9 or the female housing 71 is temporarily set as shown in FIG. 10) and enables pushdown of the moving plate 40 by the female housing 71 after the contact with the boss 44 is released by the forward movement operation (indicated by the arrow X in FIG. 11) of the lever 30 is formed on the inner surface of each of the arm portions 31 of the lever 30 by being integrally projected. The lib 36 is formed in an L shape bent like surrounding a portion (the upper side and the back side) of the boss 44. Then, the lib 36 comes into contact with the boss 44 when the female housing 71 is detached and, as shown in FIGS. 9 and 17, the moving plate 40 is returned to its original position of lifting completion by the backward movement operation (indicated by the arrow Y in FIG. 15) of the lever 30.

Further, as shown in FIGS. 5 and 6, the protruding piece 37 is formed in the center of the operation portion 32 of the lever 30 by being integrally projected. The protruding piece 37 has the locking hole 38 to lock the locking protrusion 29a of the elastic locking piece 29 of the male housing 21 formed therein.

As shown in FIGS. 10 to 13, the moving plate 40 is made movable in a forward and backward direction between an initial position located on an opening side of the hood portion 21a of the male housing 21 and a fitting position located on the back side of the hood portion 21a. Also, as shown in FIGS. 1 and 6, the moving plate 40 is made of synthetic resin and integrally formed in a U shape from a plate main body 41 in a rectangular plate shape and both sidewall portions 42, 42 projecting forward from both side ends of the plate main body 41. A plurality of positioning holes 43 is lined up and formed in the plate main body 41. When, as shown in FIG. 4A, the moving plate 40 is in the initial position, the tip of the tab portion 55a of the male terminal 55 is inserted into the positioning hole 43 in a positioning state to prevent the axis of the tab portion 55a from wobbling. Then, as the moving plate 40 moves toward the fitting position, the amount of protrusion forward from the positioning hole 43 of the tab portion 55a increases gradually. Also, the boss 44 that is brought into contact with and detached from the lib 36 of the lever 30 is formed on the upper front side of the sidewall portion 42 by being integrally projected. Further, a locking portion 45 that temporarily locks the moving plate 40 by being elastically locked by the inner surface of the sidewall of the hood portion 21a is formed on the back side of the center of the sidewall portion 42 by being integrally projected.

As shown in FIGS. 1 to 4, the male sub-housing 50 is formed from synthetic resin in a substantially square block shape and accommodated in the sub-housing accommodation chamber 22 of the male housing 21 by being inserted from a backward direction. A plurality of the cavities 51 capable of accommodating the male terminal 55 connected to the end of a wire 56 is formed throughout the inside of the male sub-housing 50 in the forward and backward direction. A lance (not shown) with flexibility that prevents the male terminal 55 from coming off is formed on the inner wall of the cavity 51. Also, a spacer mounting hole 53 communicating with each of the cavities 51 is formed in the male sub-housing 50 by opening to the top surface. A spacer 54 is inserted into the spacer mounting hole 53 from above and the male terminal 55 is doubly locked by the spacer 54 inserted up to the regular depth of the spacer mounting hole 53 and the lance (not shown).

As shown in FIG. 1, the male coaxial sub-housing 60 is formed from synthetic resin in a substantial block shape long in the forward and backward direction and accommodated by being inserted into the sub-housing insertion hole (not shown) of the male housing 21 from the backward direction. A cavity 61 that accommodates a coaxial terminal (not shown) is formed in the center of the male coaxial sub-housing 60. A lance 62 with flexibility locked by the coaxial terminal is formed on the inner wall of the cavity 61 by being integrally projected.

As shown in FIG. 1, the female housing 71 is formed from synthetic resin in a rectangular box shape and the sub-housing accommodation chamber 72 accommodating the female sub-housing 80 and the sub-housing insertion hole 73 accommodating the female coaxial sub-housing 90 are formed in a substantial center thereof like passing through in the forward and backward direction. Also, large and small terminal accommodation chambers 74a, 74b accommodating power supply circuit terminals and signal circuit terminals (not shown) are formed around the sub-housing accommodation chamber 72 and the sub-housing insertion hole 73 of the female housing 71 like passing through in the forward and backward direction. Further, the cam follower 75 like a pin engaged with the cam groove 34 of the lever 30 is formed in the substantial center on both side faces of the female housing 71 by being integrally projected. Further, a pair of the guide protrusions 76, 77 for each of the groove portion 25 in a notched shape and the receiving groove 26b in a notched shape of the hood portion 21a of the male housing 21 is formed in positions on both side faces of the female housing 71 sandwiching the cam follower 75 by being integrally projected.

As shown in FIG. 1, the female sub-housing 80 is formed from synthetic resin in a substantial square block shape and accommodated in the sub-housing accommodation chamber 72 of the female housing 71 by being inserted from the backward direction. A plurality of cavities 81 capable of accommodating a female terminal 85 connected to the end of a wire 86 is formed inside the female sub-housing 80 by passing through in the forward and backward direction. A lance (not shown) with flexibility that prevents the female terminal 85 from coming off is formed on the inner wall of each of the cavities 81. Also, a spacer mounting hole (not shown) communicating with each of the cavities 81 is formed in the female sub-housing 80 by opening to the top surface. A spacer 84 is inserted into the spacer mounting hole from above and the female terminal 85 is doubly locked by the spacer 84 inserted up to the regular depth of the spacer mounting hole and the lance (not shown).

As shown in FIG. 1, the female coaxial sub-housing 90 is formed from synthetic resin in a substantial block shape long in the forward and backward direction and accommodated by being inserted into the sub-housing insertion hole 73 of the female housing 71 from the backward direction. A cavity 91 that accommodates a coaxial terminal (not shown) is formed in the center of the female coaxial sub-housing 90. A lance 92 with flexibility locked by the coaxial terminal is formed on the inner wall of the cavity 91 by being integrally projected.

According to the lever type connector 10 in an embodiment described above, as shown in FIGS. 6 and 7, the lever 30 and the moving plate 40 are mounted on the male housing 21. At this point, the lib 36 of the lever 30 and the boss 44 of the moving plate 40 are set apart.

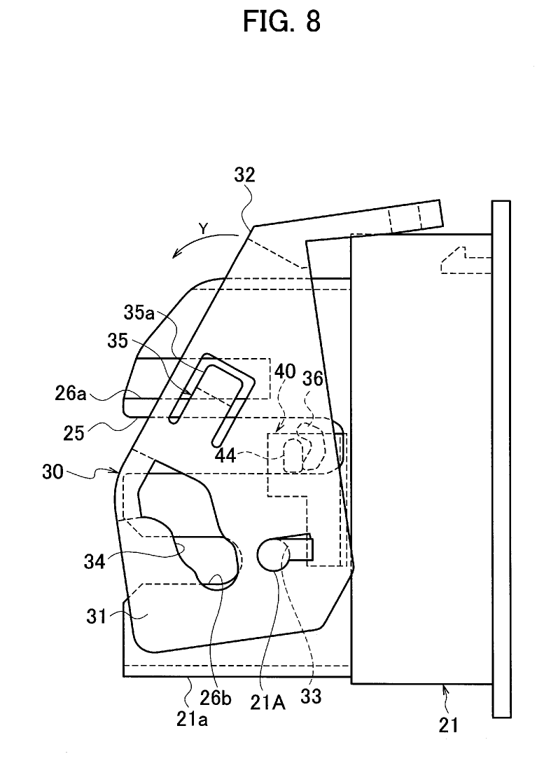

Then, when, as shown in FIG. 8, the backward movement operation Y of the lever 30 is performed, the lib 36 of the lever 30 comes into contact with and presses against the boss 44 of the moving plate 40, as shown in FIG. 9, to lift and return the moving plate 40 to its initial position (original position). At this point, the lever 30 is in a temporarily locked state by the locking protrusion 35a of the elastic locking piece 35 of the lever 30 being elastically locked into the groove surface of the groove portion 25 in a notched shape on the sidewall of the hood portion 21a of the male housing 21. While the lever 30 is temporarily locked, the moving plate 40 is prevented from being pushed by the contact of the lib 36 of the lever 30 with the boss 44 of the moving plate 40. That is, the lib 36 of the lever 30 prevents the moving plate 40 from moving to the back side inside the hood portion 21a of the male housing 21.

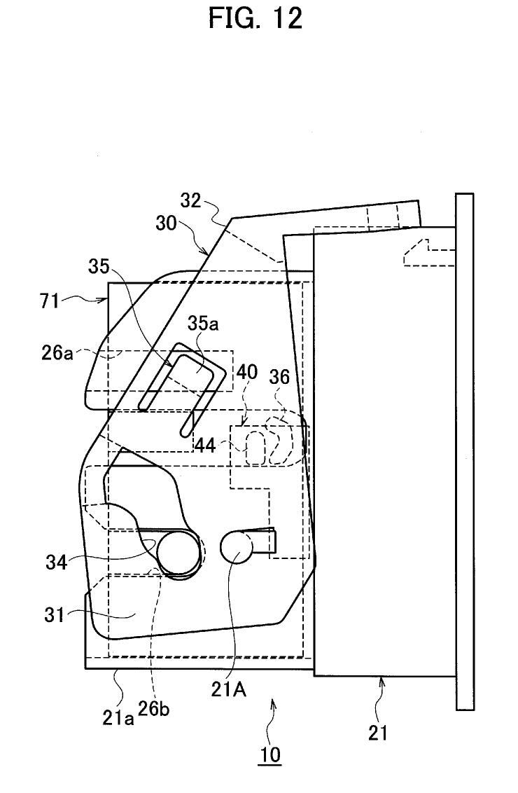

If, as shown in FIG. 10, the female housing 71 is set into the hood portion 21a of the male housing 21 (an unfitted state of the female housing 71) and, as shown in FIG. 11, the forward movement operation X of the lever 30 is performed, as shown in FIG. 12, movement of the moving plate 40 is enabled by the movement of the lib 36 of the lever 30 (the lib 36 moves away from the boss 44). Then, as shown in FIG. 13, the female housing 71 is moved to the back side inside the hood portion 21a together with the moving plate 40 to be fitted into the male housing 21.

Thus, by providing the lib 36 that comes into contact with the boss 44 of the moving plate 40 when the female housing 71 is not fitted and whose contact with the boss 44 is released by the forward movement operation X of the lever 30 to enable the female housing 71 to push the moving plate 40 by being projected from the arm portion 31 of the lever 30, the moving plate 40 can be prevented from being pushed by the lib 36 when the lever 30 is temporarily locked and also the male and female housings 21, 71 can be fitted by the forward movement operation X of the lever 30 to move the female housing 71 to the back side in the hood portion 21a of the male housing 21 together with the moving plate 40 using a weak insertion force.

Also, as shown in FIGS. 14 to 17, the lib 36 of the lever 30 is in an L shape when the connector is detached and thus, the lib 36 in the L shape draws the boss 44 of the moving plate 40 to lift and return the moving plate 40 to its original position together with the backward movement operation Y of the lever 30.

Thus, by controlling the movement of the moving plate 40 or moving the moving plate 40 by causing the boss 44 of the moving plate 40 to come into contact with or to be detached from the lib 36 of the lever 30, instead of the cam groove 34 of the lever 30, constraints of the physical relationship between the lever 30 and the moving plate 40 are eliminated when the lever 30 or the moving plate 40 is replaced so that the lever 30 or the moving plate 40 can easily be assembled in a short time. Accordingly, when the lever 30 or the moving plate 40 is replaced, the occurrence of damage or the like of the lever 30 and the moving plate 40 can reliably be prevented.

Also, by returning the moving plate 40 to its original position by the backward movement operation Y of the lever 30 after the lib 36 of the lever 30 comes into contact with the boss 44 of the moving plate 40 when the female housing 71 is detached. The moving plate 40 can easily and reliably be returned to its original position by lifting the boss 44 of the moving plate 40 like being drawn to the lib 36 of the lever 30 when the connector is detached.

Further, by forming the lib 36 of the lever 30 in an L shape bent like surrounding a portion of the boss 44 of the moving plate 40, the lib 36 can easily and reliably be prevented from coming off the boss 44 when the moving plate 40 is lifted to return to its original position.

Also, by forming, as shown in FIGS. 4A and 4B, the sub-housing accommodation chamber 22 accommodating the male sub-housing 50 accommodating and holding he male terminal 55 in the male housing 21 and the tab insertion hole 24 allowing the tab portion 55a of the male terminal 55 to pass through as a tab deformation detection mechanism in the partition wall 23 that partitions the hood portion 21a of the male housing 21 and the sub-housing accommodation chamber 22, deformation of the tab portion 55a of the male terminal 55 can easily and reliably be detected before the male sub-housing 50 accommodating and holding the male terminal 55 whose tab portion 55a is deformed is fitted into the sub-housing accommodation chamber 22 of the male housing 21 so that fitting defective products of the male and female housings 21, 71 can be eliminated. Accordingly, malfunctioning of tab deformation defective products in a process of manufacturing wire harnesses made of a plurality of wires 56 to which the male terminal 55 having the tab portion 55a attached to the lever type connector 10 is connected can be eliminated as soon as possible.

Also, by fitting the female housing 71 into the male housing 21 by causing the lever 30 to perform the forward movement operation X to move the female housing 71 to the back side in the hood portion 21a of the male housing 21 together with moving plate 40, operability of the moving plate 40 can further be improved.

Further, by forming the tab insertion hole 24 of the partition wall 23 in the same position as that of the positioning hole 43 formed in the moving plate 40 with the same diameter as that of the positioning hole 43, the tab deformation detection mechanism can easily be created at low cost.

According to the above embodiment, the tab insertion hole allowing the tab portion to pass through as a tab deformation detection mechanism in the partition wall that partitions the hood portion of the male housing and the sub-housing accommodation chamber is formed, but if there is no partition wall between the hood portion and the sub-housing accommodation chamber formed like passing through the male housing in the forward and backward direction, a tab deformation detection plate in which a tab insertion hole allowing the tab portion of the male terminal to pass through is formed may he fitted into the sub-housing accommodation chamber passing through in the forward and backward direction as a tab deformation detection mechanism.

Also according to the above embodiment, the lever type is adopted for the connector, but the above embodiment can also be applied to a connector that is not of the lever type, as a matter of course. Further, the operation of the lever may be, instead of the rotation, a sliding operation.

What is claimed is:

1. A connector comprising:
a housing provided with a sub-housing accommodation chamber accommodating a sub-housing to accommodate and hold a male terminal, and fitted into or detached from a counterpart housing, wherein
a tab deformation detection mechanism that detects deformation of a tab portion of the male terminal is provided in the housing.

2. The connector according to claim 1, wherein
a partition wall partitioning the sub-housing accommodating chamber is provided with a tab insertion hole as the tab deformation detection mechanism through which the tab portion is inserted.

3. The connector according to claim 1, further comprising:
a male housing as the housing having a hood portion;
a lever supported by the male housing via a spindle;
a moving plate that positions the tab portion inside the hood portion; and
a female housing as the counterpart housing accommodating a female terminal and fitted to or detached from the hood portion, wherein
by causing the lever to perform a forward movement operation while a cam follower formed on the female housing is engaged with a cam groove formed in the lever, the female housing is fitted into the male housing by moving the female housing to a back side in the hood portion together with the moving plate.

4. The connector according to claim 1, further comprising:
a male housing as the housing having a hood portion;
a lever supported by the male housing via a spindle;
a moving plate that positions the tab portion inside the hood portion; and
a female housing as the counterpart housing accommodating a female terminal and fitted to or detached from the hood portion, wherein
by causing the lever to perform a forward movement operation while a cam follower formed on the female housing is engaged with a cam groove formed in the lever, the female housing is fitted into the male housing by moving the female housing to a back side in the hood portion together with the moving plate,
wherein a partition wall partitioning the sub-housing accommodating chamber is provided with a tab insertion hole as the tab deformation detection mechanism through which the tab portion is inserted,
wherein the tab insertion hole is formed in a same position as that of a positioning hole formed in the moving plate with a same diameter as that of the positioning hole.
